(19) United States
(12) Patent Application Publication
(10) Pub. No.: US 2025/0129624 A1
(43) Pub. Date: Apr. 24, 2025

(54) VENDING MACHINE SHIPPING CONTAINER WITH INTEGRATED ADVERTISING SCREENS POWERED BY SOLAR PANELS

(71) Applicant: Tiffany Ann Logan, Rancho Cucamonga, CA (US)

(72) Inventor: Tiffany Ann Logan, EASTVALE, CA (US)

(21) Appl. No.: 18/382,534

(22) Filed: Oct. 23, 2023

(51) Int. Cl. E04H 1/12; B65D 88/12; B65D 90/00; G06Q 30/0241; H02S 99/00

(52) U.S. Cl. CPC E04H 1/1222; B65D 88/121; B65D 90/0086; G06Q 30/0276; H02S 99/00; B65D 2590/0083; E04H 2001/1283

(57) ABSTRACT

The present invention discloses a vending machine shipping container that transcends the conventional boundaries of product transportation and advertising. This innovative container merges the functionality of safeguarding vending machines during transit with the dynamic potential of advertising. It features an outer shell designed to securely house and transport vending machines, with overhead awing provide shade and shelter from weather and integrated advertising screens strategically positioned on the container's sides and front showing images or information about products, company name, purpose of showcasing to attract people passing by. These high-resolution screens enable the presentation of dynamic, eye-catching advertisements. The container also incorporates power sources by solar panel, allowing it to display content and receive real-time updates via internet connectivity. This novel approach not only ensures the safe transit of vending machines but also transforms the container into a powerful advertising platform, revolutionizing the vending and shipping industries.

Conclusion

The described vending machine shipping container with integrated advertising screens represents a significant advancement in the vending and shipping industries. It combines the protection of vending machines during transit with an innovative approach to advertising.

### BACKGROUND OF THE INVENTION

### Field of Invention

This patent application relates to the field of vending machines and shipping containers. Specifically, it pertains to a vending machine shipping container with integrated advertising screens powdered by solar panels.

### Description of Related Art

Vending machines have been widely used for dispensing various products, such as snacks, beverages, and more, lot of problem is faced during their movement therefore they are enclosed a shipping container for safe shipmemt. Simultaneously, the advertising industry continuously seeks innovative ways to capture the attention of potential customers. The Vending Machine Shipping Container with Integrated Advertising Screens powered by solar panels combines these two elements, offering a multifunctional and eco-friendly solution that addresses multiple needs in a single package.

### SUMMARY OF THE INVENTION

The present invention discloses a unique vending machine shipping container designed to transport and house vending machines while incorporating advertising screens. This innovative container not only protects the vending machine during shipping but also serves as a marketing platform through its advertising screens which are powered by solar panels.

### BRIEF DESCRIPTION OF THE DRAWINGS

FIG. 1 shows an overall view;

FIG. 1(1) shows 4 Solar Panels for Power provides renewable energy to power the vending machines and other electronic components within the container. This allows for sustainable and environmentally friendly operation;

FIG. 1(2) shows 1 Overhead Awning (15 ft long) provides shade and protection from the weather for customers while they browse and make their purchases;

FIG. 1(3) shows 5 Vending Machines with Products are the core components of your vending machine container. They dispense products to customers when they make a purchase and protection from the weather for customers while they browse and make their purchases;

FIG. 1(4) shows 5 Smaller Advertisement Display Screens are located above each vending machine and serve the purpose of showcasing advertisements and promotions to attract customers' attention and encourage sales;

FIG. 1(5) shows 1 LED Logo Sign with LED Lettering is a prominent display that showcases your brand or company logo, attracting attention and making your vending machine container easily identifiable;

FIG. 1(6) shows 1-20 ft. Converted Shipping Container serves as the main structure of your vending machine container. It provides a secure and weather-resistant enclosure for all the vending machines and other components;

FIG. 2 shows right side view;

FIG. 2(1) shows 4 Solar Panels for Power provide renewable energy to power the vending machines and other electronic components within the container. This allows for sustainable and environmentally friendly operation;

FIG. 2(2) shows 1 Overhead Awning (15 ft. long) provides shade and protection from the weather for customers while they browse and make their purchase's;

FIG. 2(4) shows 5 Smaller Advertisement Display Screens are located above each vending machine and serve the purpose of showcasing advertisements and promotions to attract customers' attention and encourage sales;

FIG. 2(5) shows 1 LED Logo Sign with LED Lettering is a prominent display that showcases your brand or company logo, attracting attention and making your vending machine container easily identifiable;

FIG. 2(6) shows 120 ft. Converted Shipping Container serves as the main structure of your vending machine container. It provides a secure and weather-resistant enclosure for all the vending machines and other components;

FIG. 3 shows left side view;

FIG. 3(1) shows 4 Solar Panels for Power provides renewable energy to power the vending machines and other electronic components within the container. This allows for sustainable and environmentally friendly operation;

FIG. 3(2) shows 1 Overhead Awning (15 ft. long) provides shade and protection from the weather for customers while they browse and make their purchase's;

FIG. 3(4) shows 5 Smaller Advertisement Display Screens are located above each vending machine and serve the purpose of showcasing advertisements and promotions to attract customers' attention and encourage sales;

FIG. 3(5) shows 1 LED Logo Sign with LED Lettering is a prominent display that showcases your brand or company logo, attracting attention and making your vending machine container easily identifiable;

FIG. 3(7) shows 1-8×8 Large Outdoor Advertising Display Screen, located on the outside of the container, is an additional advertising medium that can showcase dynamic and eye-catching advertisements to attract customers passing by;

FIG. 4 shows top view of vending machine container;

FIG. 4(1) shows 4 Solar Panels for Power provides renewable energy to power the vending machines and other electronic components within the container. This allows for sustainable and environmentally friendly operation;

FIG. 4(2) shows 1 Overhead Awning (15 ft. long) provides shade and protection from the weather for customers while they browse and make their purchase's;

FIG. 4(5) shows 1 LED Logo Sign with LED Lettering is a prominent display that showcases your brand or company logo, attracting attention and making your vending machine container easily identifiable;

FIG. 5 shows a right side and front view;

FIG. 5(2) shows 1 Overhead Awning (15 ft. long) provides shade and protection from the weather for customers while they browse and make their purchases;

FIG. 5(3) shows 5 Vending Machines with Products are the core components of your vending machine container. They dispense products to customers when they make a purchase.nd protection from the weather for customers while they browse and make their purchases;

FIG. 5(4) shows 5 Smaller Advertisement Display Screens are located above each vending machine and serve the purpose of showcasing advertisements and promotions to attract customers' attention and encourage sales;

FIG. 5(5) shows 1 LED Logo Sign with LED Lettering is a prominent display that showcases your brand or company logo, attracting attention and making your vending machine container easily identifiable;

FIG. 5(6) shows 1-20 ft. Converted Shipping Container serves as the main structure of your vending machine container. It provides a secure and weather-resistant enclosure for all the vending machines and other components.

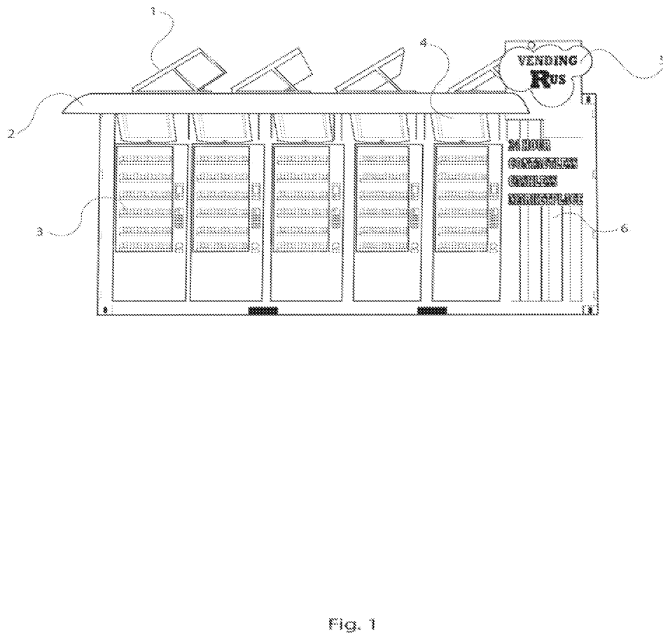

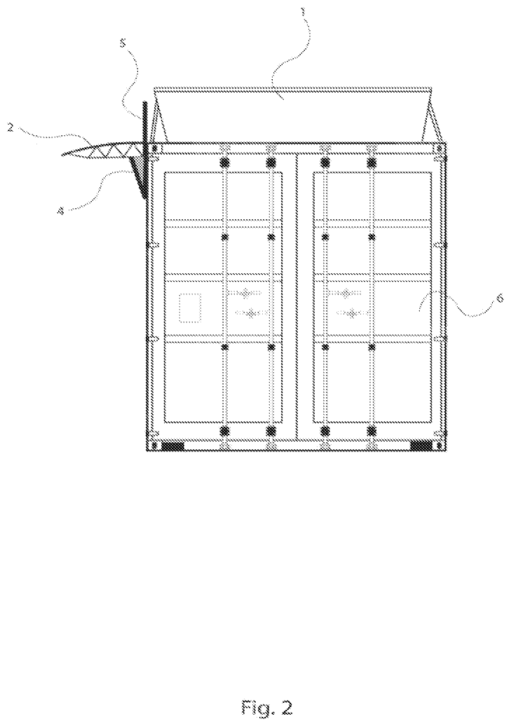

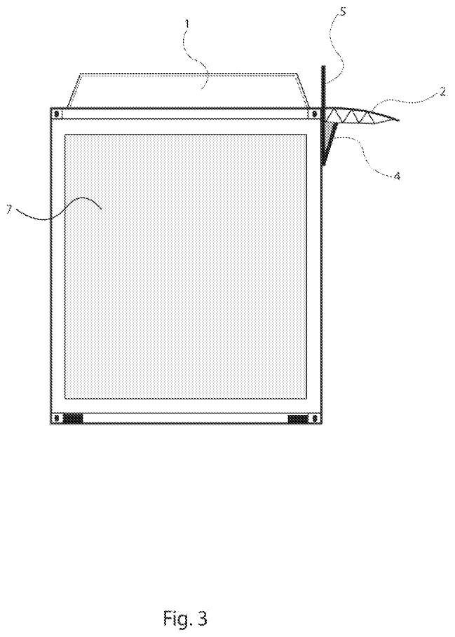

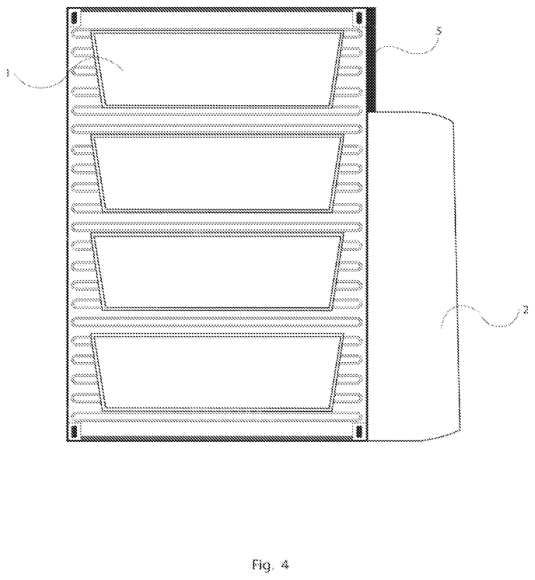

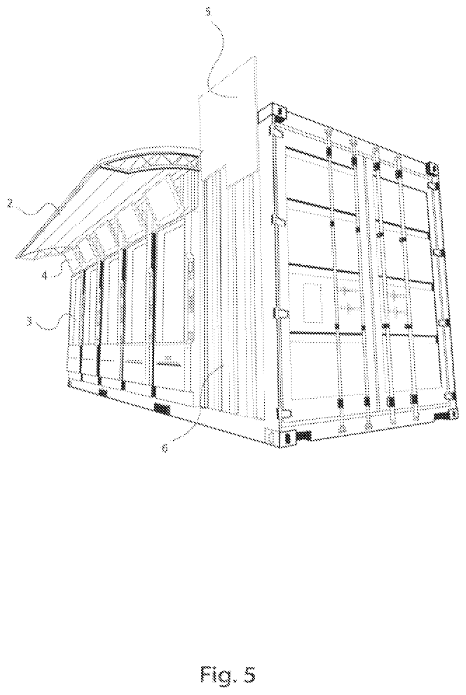

### DETAILED DESCRIPTION OF INVENTION

### 1. Introduction:

Vending Machine Shipping Container: The invention comprises a shipping container designed to securely hold and transport vending machines.
Integrated Advertising Screens: The container is equipped with integrated advertising screens that display dynamic advertisements to a wide audience.
Overhead awing: The overhead awning provides shade and protection from the weather for customers while they browse and make their purchases.

4 Solar Panels for Power: The solar panels provide renewable energy to power the vending machines and other electronic components within the container. This allows for sustainable and environmentally friendly operation.

### 2. Container Structure:

Material: The container is constructed from durable, impact-resistant materials to ensure the safety of the enclosed vending machine, an outer overhead awing for providing shelter and protection to clients from weather
Dimensions: The container is designed to accommodate various vending machine sizes.
Security Features: It includes locking mechanisms and shock-absorbing elements for added protection.

### 3. Advertising Screens:

Number and Placement: The container features advertising screens strategically placed on its sides and front for maximum visibility. These are of 3 types 1 type having 5 on each vending machine to advertise products, 2nd type have larger screen on side and 3rd one type is LED logo sign to show brand.
Technology: These screens utilize state-of-the-art technology for high-resolution displays and can be easily updated remotely.

### 4. Power and Connectivity:

Power Source: The container is equipped with a power source of 4 solar panels.
Connectivity: It can connect to the internet or other data sources for real-time content updates.

1. A vending machine shipping container comprising:
An outer shell for housing and protecting vending machine components;
An overhead awing to provide shade and shelter from weather;
7 advertising screens integrated into the outer shell;
4 Solar panels positioned on the outer surface of the container to provide power to the advertising screens;
A power management system to control the flow of solar-generated electricity to the advertising screens;

2. A vending machine shipping container as claimed in claim 1, wherein the outer shell is made of a durable, weather-resistant material to protect the vending machine and advertising screens having overhead awing provides shade and protection from the weather for customers while they browse and make their purchase's;

3. The vending machine shipping container of claim 1, wherein the advertising screens are of 3 types, 5 Smaller Advertisement Display Screens are located above each vending machine and serve the purpose of showcasing advertisements and promotions to attract customers' attention and encourage sales, 1 LED Logo Sign with LED Lettering a prominent display that showcases brand or company logo, attracting attention and making vending machine container easily identifiable, 1-8×8 Large Outdoor Advertising Display Screen located on the outside of the container, is an additional advertising medium that can showcase dynamic and eye-catching advertisements to attract customers passing by;

4. The vending machine shipping container of claim 1, further comprising a data communication system to remotely update and manage content displayed on the advertising screens;

5. A method for operating a vending machine shipping container as claimed in claim 1, comprising:
Receiving solar energy through the solar panels;
Converting the solar energy into electricity;
Providing power to the advertising screens with the converted electricity;
Displaying advertisements and content on the advertising screens;
Managing and updating content on the advertising screens remotely.
